(19) United States
(12) Patent Application Publication
(10) Pub. No.: US 2024/0382026 A1
(43) Pub. Date: Nov. 21, 2024

(54) TEMPERATURE CONTROLLED CHARCUTERIE BOARD

(71) Applicants: Megan Robinson, Palm Harbor, FL (US); Kathleen Robinson, Palm Harbor, FL (US)

(72) Inventors: Megan Robinson, Palm Harbor, FL (US); Kathleen Robinson, Palm Harbor, FL (US)

(21) Appl. No.: 18/666,329

(22) Filed: May 16, 2024

Related U.S. Application Data
(63) Continuation of application No. 63/467,312, filed on May 18, 2023.

(51) Int. Cl. A47G 23/06; A45C 3/00; A45C 13/10; A47J 47/00; B65D 25/02; B65D 25/28; B65D 81/18

(52) U.S. Cl. CPC A47G 23/0683; A45C 3/00; A45C 13/103; A47J 47/005; B65D 25/02; B65D 25/2808; B65D 81/18; A47G 2023/0691

(57) ABSTRACT

A food serving device including a main body configured to receive and serve food thereon. The main body includes an internal compartment configured to receive a temperature control element therein. The food serving device also includes a panel selectively engageable with the main body and movable between a closed position and an open position. When the panel is in the closed position, the panel closes the compartment and forms a contiguous enclosure with the main body such that the temperature control element is enclosed within the compartment. When the panel is in the open position, the panel exposes the compartment such that the temperature control element can be removed from the compartment.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application is a non-provisional application of and hereby claims priority to U.S. Provisional Patent Application No. 63/467,312 entitled “TEMPERATURE CONTROLLED SERVING VESSEL”, filed on May 18, 2023.

### BACKGROUND OF THE INVENTION

The disclosure relates generally to serving dishes or plates for transporting and displaying food.

Most foods are intended to be served at a refrigerated temperature or an elevated temperature, not room temperature. Service plates, trays, and dishes generally come to room temperature relatively quickly such that the food thereon also comes to room temperature. A hot stone will keep food warm longer than a standard plate, but since the stone has no insulation, the stone loses heat quickly when exposed to room temperature. Nesting two bowls together with ice in between the bowls provides an improved system for serving cold foods, but the ice quickly melts, can become messy, and the food served thereon still comes up to room temperature relatively quickly. An electrically wired heating plate, while it maintains its temperature, needs to remain near an electricity source, is not easy to clean, and may be unsightly for certain food service needs. It also has a cord that can be a trip hazard. A self-contained, temperature-controlled serving vessel where the temperature control element is not removable, such as a wine glass that can be frozen and taken out of the freezer for use or a stone that could be heated on the grill, not only takes up valuable freezer or grill space prior to food service, but has a limited time span for use, as the temperature element is not removable or replaceable by the user and the temperature quickly reverts back to ambient room temperature. Wood planks or bowls are currently popular for food service, and they quickly attain room temperature which leads to the food served thereon coming to room temperature. Serving foods at room temperature is problematic because the texture deteriorates with many foods and as a result the intended dining experience is negatively affected. This often leads to wasted food that is either unappealing shortly after presentation or food that is unable to be preserved for later reuse. Additionally, on food that has been previously heated or cooled and then acclimated to room temperature, bacteria can grow rapidly at such temperature (as opposed to refrigeration temperature or an elevated temperature from cooking), rendering consumption potentially unsafe. Therefore, there exists a need for an improved serving device for aesthetically displaying food whilst maintaining its desired temperature.

### SUMMARY OF THE INVENTION

Aspects of the disclosure provide a food serving vessel for chilling or warming food thereon. The vessel includes a main body, a temperature control element disposed within a compartment of the main body, and one or more sliding panels that open and close the compartment, allowing a user to insert, remove, or replace the temperature control element as desired to maintain a desired temperature of the food.

In one aspect, a food serving device includes a main body configured to receive and serve food thereon. The main body includes an internal compartment configured to receive a temperature control element therein. The food serving device also includes a panel selectively engageable with the main body and movable between a closed position and an open position. When the panel is in the closed position, the panel closes the compartment and forms a contiguous enclosure with the main body such that the temperature control element is enclosed within the compartment. When the panel is in the open position, the panel exposes the compartment such that the temperature control element can be removed from the compartment.

In another aspect, a food serving device includes a main body configured to receive and serve food thereon. The main body includes an internal compartment with a compartment opening in a side of the main body. The food serving device further includes a temperature control element removably disposed within the internal compartment and configured to maintain a temperature of the food on the main body. The food serving device further includes a panel selectively slidable within the compartment opening of the main body and configured to slide in a first direction to cover the compartment opening and enclose the temperature control element within the compartment in a closed position and slide in an opposite second direction to expose the compartment opening, allowing a user to remove or insert the temperature control element within the internal compartment.

In another aspect, a food serving device includes a main body configured to receive and serve food thereon. The main body includes a top, a bottom, longitudinal sides, lateral sides, and an internal compartment with a pair of compartment openings thereof in both lateral sides. The food serving device further includes a temperature control element removably disposed within the internal compartment and configured to maintain a temperature of the food on the main body. The food serving device further includes a pair of panels selectively and respectively slidable within the pair of compartment openings of the main body. Each panel is configured to slide in a first direction to cover its respective compartment opening and enclose the temperature control element within the compartment in a closed position and slide in an opposite second direction to expose its respective compartment opening, allowing a user to remove or insert the temperature control element within the internal compartment.

### BRIEF DESCRIPTION OF THE DRAWINGS

FIG. 1 is a top perspective view of an embodiment of a serving vessel with a main body for displaying and serving food thereon, one or more removable temperature control elements housed within the main body, and sliding panels at the sides of the main body for allowing a user to insert, remove, or replace the temperature control elements even when food is present on the main body, in accordance with one aspect of the present disclosure.

FIG. 2 is a right side perspective view of the serving vessel of FIG. 1, with one side panel in its open position and the temperature control element fully inserted into the main body.

FIG. 3 is another right side perspective view of the serving vessel of FIG. 1, with one side panel in its open position and the temperature control element partially removed from the main body.

FIG. 4 is a right side perspective view of the serving vessel of FIG. 1, with one side panel in its open position and the temperature control element removed from the main body.

FIG. 5 is an exploded view of the serving vessel of FIG. 1.

FIG. 6 is a detail perspective view of a top corner of the serving vessel of FIG. 1, illustrating the connection between the sliding panel and the main body.

FIG. 7 is a detail perspective view of the top corner of the serving vessel of FIG. 6, wherein the sliding panel is removed to illustrate a magnet embedded within the main body.

FIG. 8 is a detail and perspective end view of the inner, main body-facing surface of the panel, which illustrates a corresponding magnet embedded within the panel for magnetically engaging with the magnet of the main body when the panel is fitted within the main body in the closed position of the panel.

FIG. 9 is a top perspective view of an embodiment of a temperature control element in the form of an ice pack for cooling the main body.

FIG. 10 is a top perspective view of an embodiment of a temperature control element in the form of a hot pack for heating the main body.

FIG. 11 is a top perspective view of an insulated carrying bag for fully encapsulating the serving vessel and maintaining a desired temperature of the food during transport. The carrying bag, which is shown in a closed position, generally includes a rigid bottom, rigid side walls, and an unzippable clear top.

FIG. 12 is a top perspective view of the carrying bag in an open position, with the serving vessel still housed therein.

FIG. 13 is a top perspective view of the carrying bag in a partially folded position.

FIG. 14 is a top perspective view of the carrying bag in a stored, fully folded position.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the disclosure are discussed in detail below, it should be appreciated that the disclosure provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the disclosure. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. As used herein, the upright position of the serving vessel is when the serving vessel is positioned flat to serve food on a generally horizontal surface (e.g., a table top or counter). Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without operator input or prompting, whether these features, elements and/or states are included or are to be performed in any particular embodiment.

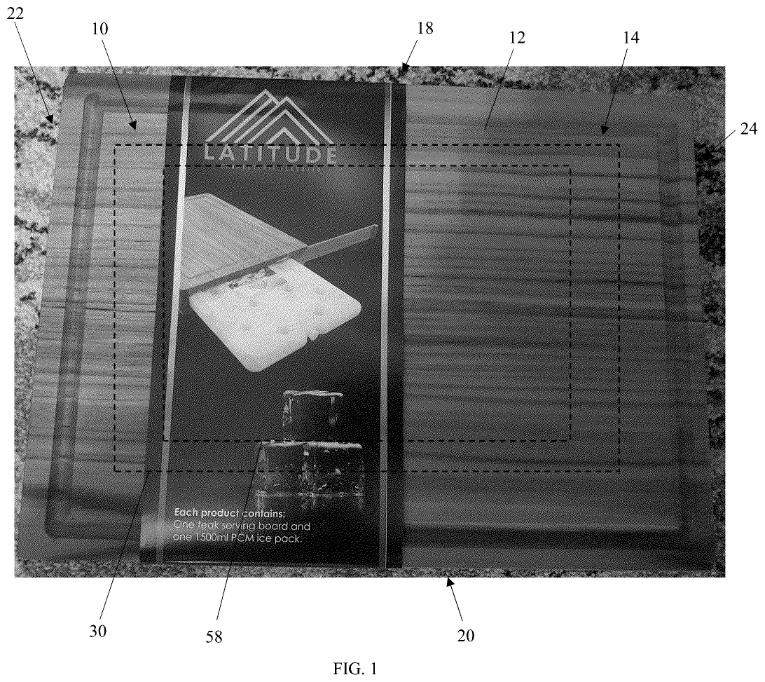

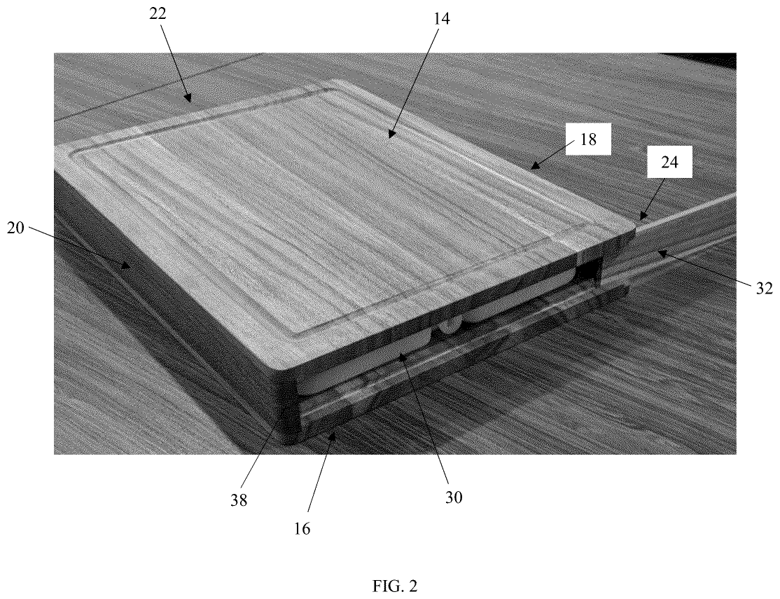

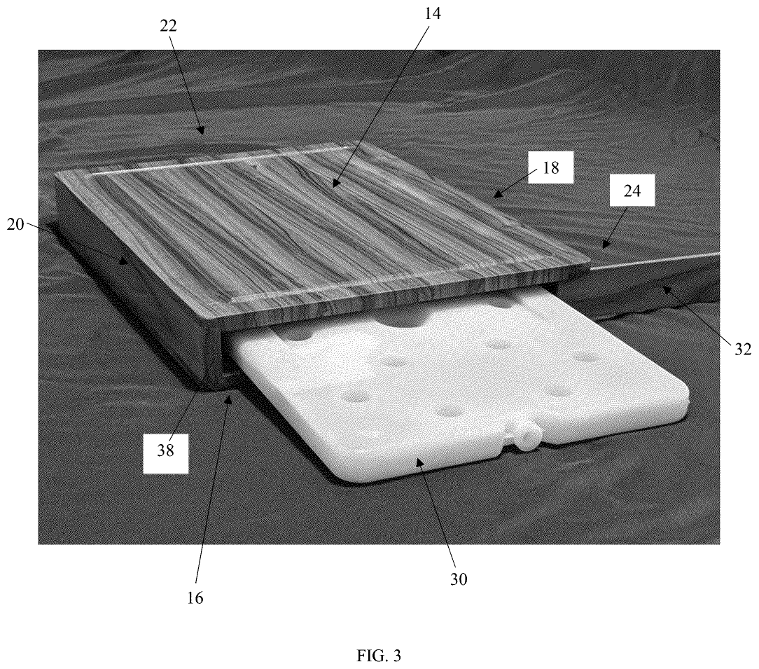

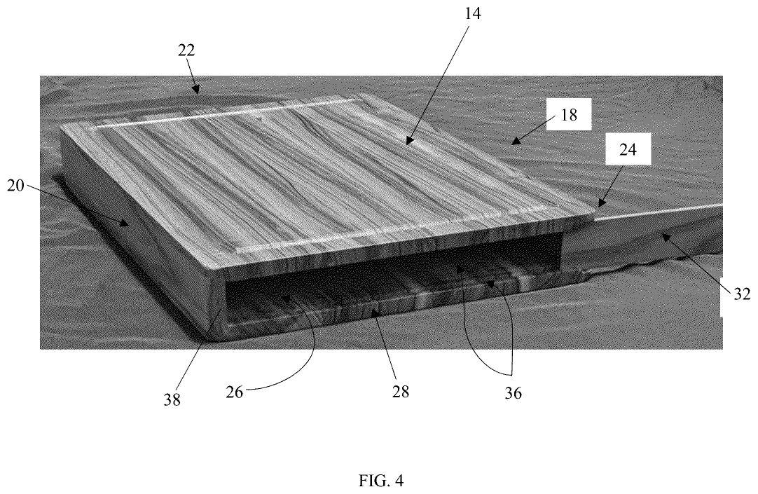

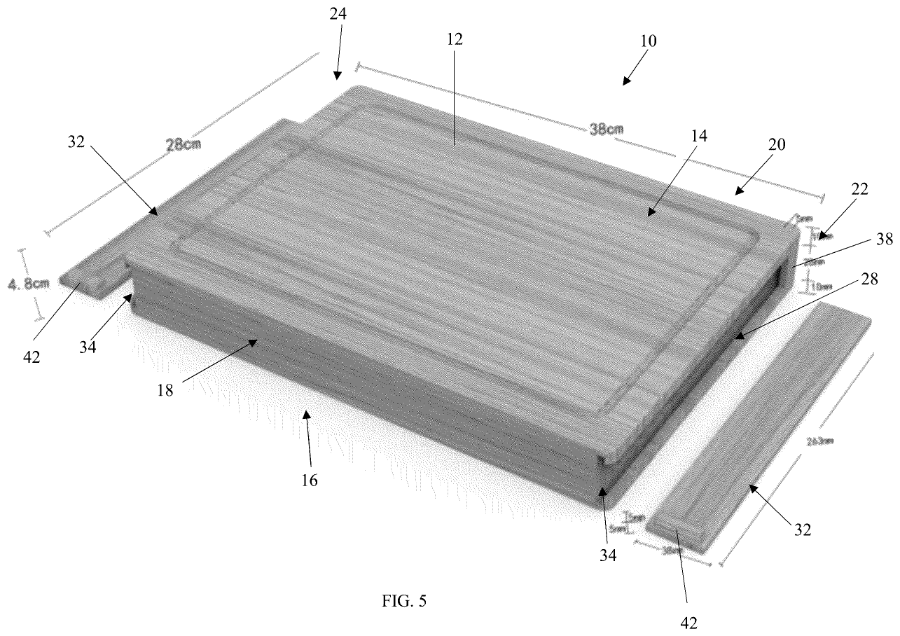

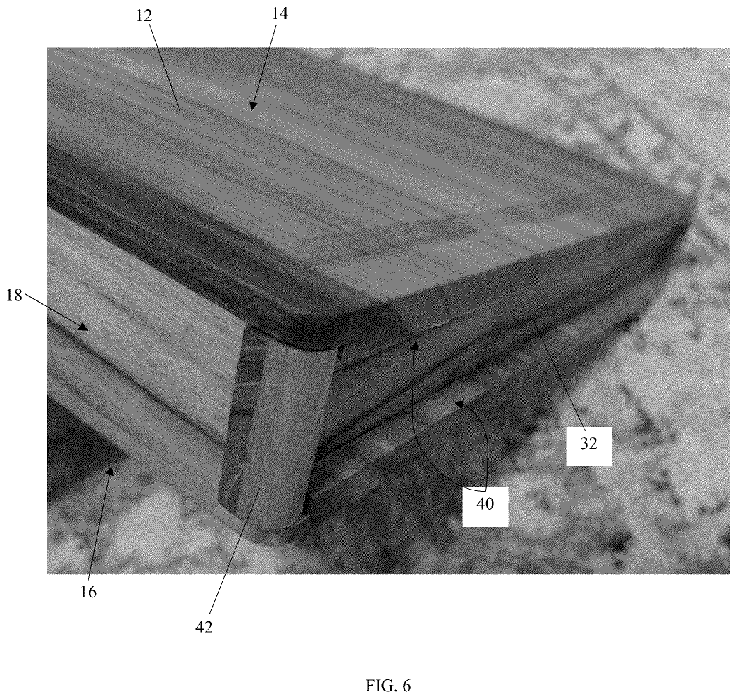

Referring generally to FIGS. 1-8, there is shown a serving device or vessel 10 for displaying, and maintaining a desired temperature of, food thereon. The serving vessel 10 includes a main body 12 configured to receive and serve food thereon. The main body 12 generally includes a top 14, a bottom 16 which faces the support surface, e.g., table, longitudinal sides 18, 20, lateral sides 22, 24 extending in between the longitudinal sides 18, 20, and an internal compartment 26 with a pair of compartment openings 28 thereof in both lateral sides 22, 24 (FIG. 4). The serving vessel 10 also includes one or more temperature control elements 30, such as only one, two, or more temperature control elements 30, that are removably disposed within the internal compartment 26. The temperature control element 30 is thus selectively enclosed within the serving vessel 10 such that heat generated by a warming temperature control element or cold retained by a cooling temperature control element is transferred to the upper surface at the top 14 of the serving vessel 10. The serving vessel 10 further includes a pair of panels 32 selectively and respectively slidable within the pair of compartment openings 28 at the sides 22, 24 of the main body 12. Hence, either or both panels 32 can be slidably engaged with the main body 12. Each panel 32 can be configured to slide in a first direction to cover its respective compartment opening 28 and enclose the temperature control element 30 within the compartment 26 in a closed position (FIGS. 1 and 6) and slide in an opposite second direction to expose its respective compartment opening 28 in an open position (FIGS. 2-4), thus allowing a user to remove or insert the temperature control element 30 within the internal compartment 26 as desired.

The serving vessel 10 solves the issue of food items left out at room temperature, thus rising or calibrating to room temperature when the food is left out for hours. This allows the food to maintain its freshness and safety for much longer than existing standard wooden serving boards, chilled stones, or standard plates. The serving vessel 10 in this case can be used for either cold food service, warm food service, or as a traditional serving board without a temperature control element 30 or insert therein to accordingly serve food at room temperature.

In another embodiment, the serving vessel 10 may be variations on serving dishes, such as but not limited to a cutting board, a charcuterie board, a bowl, a plate, a platter, or a lazy susan where the temperature control apparatus is removable or replaceable by the user and concealed within an enclosed cavity. In one embodiment, the serving vessel 10 is a wooden serving board with a hollow interior. Therein, both the main body 12 and the panels 32 can be wooden. In one embodiment, the cutting board 10 can include a drip groove within the top thereof. The shape of the drip groove can correspond to the outer perimeter of the cutting board 10.

In one embodiment, the invention includes a wooden serving board 10 with an enclosed cavity or compartment 26 therein for storing a replaceable temperature control element 30. Hence, the compartment 26 has a size and shape that corresponds to the size and shape of the main body 12. As shown, the compartment 26 has a substantially rectangular cross-section. In one embodiment, the serving vessel 10 is a wooden service board with a hollow core and slide open sides. In one embodiment, the serving vessel 10 includes a hollow board that includes at least one open side to allow access to its hollow interior. The side may open via removal of a door from one or more grooves in the main body 12 of the wooden board, or via a hinging action, or a removable top or bottom that allows a temperature element to be inserted within the board before the top or bottom is replaced.

In one embodiment, the cavity or compartment 26 of the main body 12 includes at least one compartment opening 28 that is formed in part by a lateral side 22, 24 and a longitudinal side 18 of the main body 12. One or both lateral sides 22, 24 of the main body 12 can include a compartment opening 28 therein. The compartment opening 28 extends into the longitudinal side 18 of the main body 12. In other words, a portion of the longitudinal side 18 can be cutout and accordingly form the front opening or cutout 34 of the compartment opening 28 wherein the panel 32 is initially inserted. Thus, the panel 32 is configured to slide into the compartment opening 28 from the longitudinal side 18 and inwardly until the panel 32 fully covers the compartment opening 28 in the lateral side 22, 24 of the main body 12.

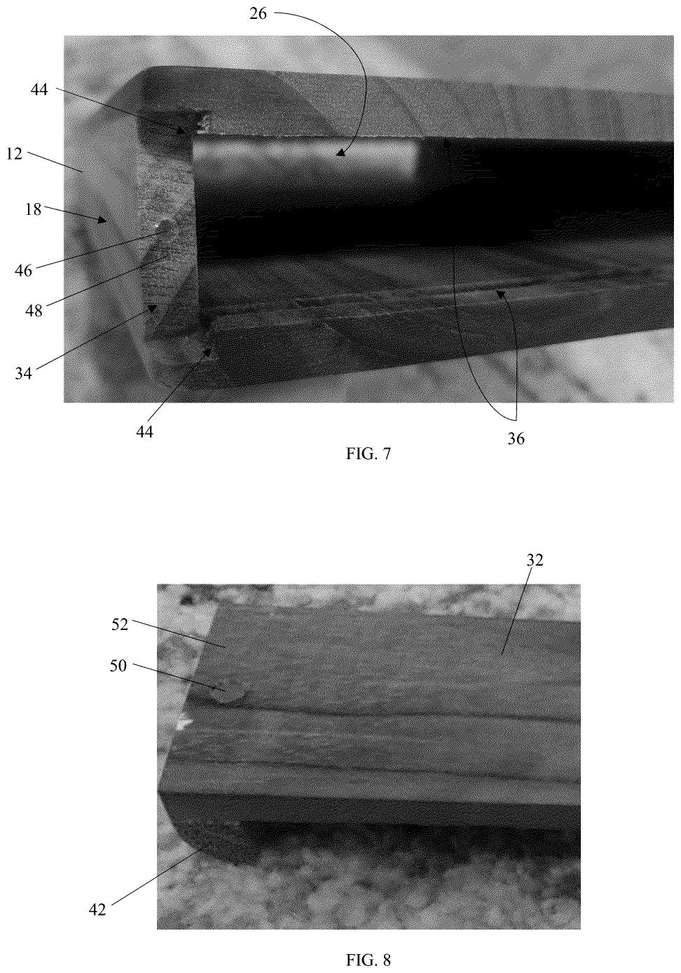

The compartment opening 28 can further include grooves 36 in the inner (underside) surfaces of the top 14 and bottom 16 (FIGS. 4 and 7). The compartment opening 28 can also include a lip 38 at its rear end, next to the longitudinal side 20, that is configured to extend over an end of the panel 32 when assembled. The lip 38 can serve as a mechanical stop 38 for locking the panel 32 in position, preventing the panel 32 from sliding further inward and/or from moving laterally outward. In one embodiment, the lip 38 can have a groove therein that is configured to receive the end of the panel 32. In one embodiment, the grooves 36 can be positioned laterally inward of the edges of the lateral sides 22, 24 such that each panel 32 is slightly recessed from the outer perimeter of the main body 12, and accordingly the lip 38 extends over the outer surface of the panel 32 when the panel 32 is fully seated within the grooves 36. Advantageously, this recess accordingly forms top and bottom hand railings 40 at each lateral side 22, 24 which allow the user to easily grip and manipulate the serving vessel 10, even when fully assembled (FIG. 6).

In one embodiment, the panel 32 may comprise an elongated side panel 32 with a shape and size that corresponds to the open side, e.g. the rectangular compartment opening 28, of the main body 12 such that the elongated side panel 32 fully covers the open side in the closed position. Therein, the panel 32 can include an elongated and rectangular body with a first end, a second end opposite the first end, and a middle section extending therebetween. A handle 42 can be connected at the first end. The handle 42 comprises a rounded protrusion 42 extending outwardly from the elongated and rectangular body. The handle 42 can be perpendicular to a longitudinal axis of the panel 32 and extend from the top to the bottom of the panel 32. When assembled in the closed position, the handle 42 forms a seamless corner with the main body 12, such that the handle 42 matches the contour of the main body 12. As shown in FIG. 6, the outer perimeter of the handle 42 sits flush with the outer perimeter of the corners of the main body 12. Additionally, the handle 42 can mate with ledges 44, defined by the front cutout 34, of the compartment opening 28 at the longitudinal side 18. The ledges 44 may serve as a mechanical stop for abutting against the handle 42, thus preventing the panel 32 from sliding further inwardly. The handle 42 can have a cross-section that is semicircular or any other desired shape.

In one embedment, the panel 32 can include mating features that slidably and respectively engage with the corresponding grooves 36 in the main body 12. The mating features may include tabs, tongues, or protrusions that fit within the grooves in the main body 12.

Referring specifically to FIGS. 7-8, in one embodiment, each panel 32 can be magnetically coupled to the main body 12. For example, the main body 12 can further include a magnet 46 embedded within a panel-mating surface 48, and the panel 32 can include a corresponding magnet 50 in a body-mating surface 52 that faces the panel-mating surface 48 of the main body 12 such that when the magnets 46, 50 are aligned, the panel 32 is magnetically engaged with the main body 12 in the closed position. In more detail, as shown in FIG. 7, the lateral facing surface 48 at the end of the first longitudinal side 18 of the main body 12 includes one magnet 46 embedded within a magnet recess (unnumbered), which placed next to the cutout 34 of the compartment opening 28. As shown in FIG. 8, the inner, body-mating surface 52 of the panel 32, opposite the handle 42, can include one magnet 50 embedded within a magnet recess (unnumbered). The magnets 46, 50 can be any desired magnets, such as neodymium magnets. The main body 12 and each panel 32 can have only one paired magnet set or multiple paired magnets located at any desired location(s) thereof.

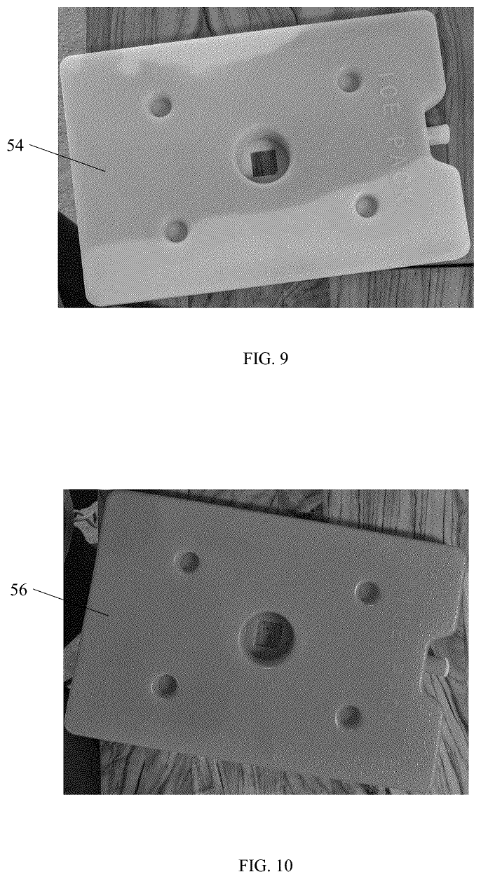

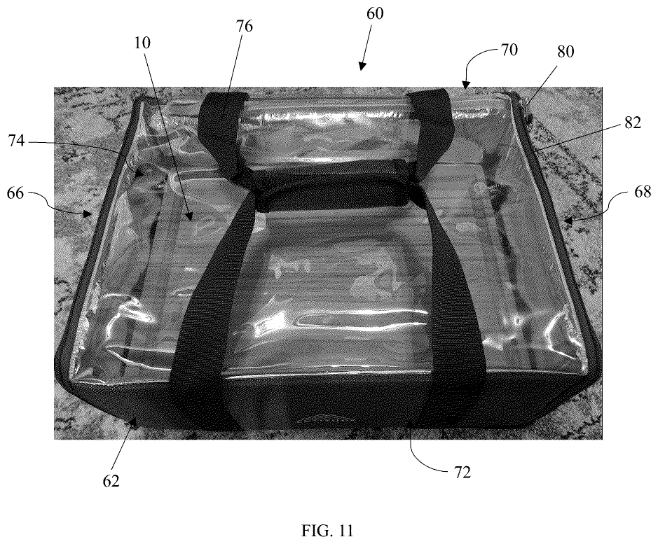

Referring to FIGS. 9-10, the temperature control element 30 can be a cooling element 54 (FIG. 9) or a heating element 56 (FIG. 10). In one embodiment, an ice pack 54 which is enclosed in the main body 12 has the ability to hold a surface temperature of the top 14 at around 50 to 60 degrees fahrenheit for at least three hours. The panel(s) 32 of the board 10 allows for multiple ice packs 54 to be interchanged mid service, keeping the surface of the board in the range of 50 to 60 degrees fahrenheit for multiple hours (at least 3 hours per fully frozen ice pack) when used indoors or out of direct sunlight. The heating device or hot pack 56 allows for the surface of the board 10 to be warm, if used for warm food items. The heating device 56 is likewise interchangeable while in use due to the slide, twist, or hinge-open side of the serving vessel 10 which allows access to the internal cavity of the serving vessel 10.

In one embodiment, the temperature control element 30 is a hard side pack which itself contains an inner material (i.e., a plastic case enclosing a coolable or heatable fluid or gel). The pack may be frozen to provide a cold serving dish or heated to provide a hot serving dish. In another embodiment, the temperature control element 30 is a chemical hot pack (e.g., air activated chemical hand warmer) or a reusable chemical warmer (e.g., a gel pack that is activated by clicking a disk in the pack to begin changing the state of the gel to a solid, thereby releasing heat). For example, 1000 ml ice packs and/or 1000 ml hot gel packs may be used for temperature support. The heating element may also eventually be a battery assisted cooling or warming device, chemical heat or cooling pouch, hot stone, or other material or device that maintains or changes temperature.

In another embodiment, the temperature control element 30 is a refillable casing (e.g. soft or hard plastic) with a substance such as liquid or gel that is added by the user into the casing before the casing is sealed and inserted as a whole into the cavity 26. In another embodiment, the temperature control insert and/or temperature control mechanism 30 is a solid material (e.g., plastic, stone, glass, or other such material) that is heated or cooled before insertion. In another embodiment, the insert and/or temperature control mechanism 30 is a fully removable, battery-powered and/or rechargeable element that may be heated or cooled before insertion, and can be removed from the unit as needed for replacement or recharging.

In one embodiment, a companion or secondary cutting board 58 may also be included and housed within the compartment 26, as shown in phantom in FIG. 1. The cutting board 58 may be comprised of any desired material, such as wood or plastic. The cutting board 58 in the present embodiment is made of plastic. The secondary cutting board 58 allows the user to easily and quickly cut food items without needing to cut directly on the surface of the main body 12, thus avoiding knife marks on the wood. This secondary cutting board 58 fits above or underneath the temperature control element 30 for storage and also insulation of the top or bottom of the cavity 26 from the temperate control element 30. The temperature control element(s) 30 and additional cutting board 58 are completely enclosed in the wooden main body 12 when in use. As can be appreciated, multiple temperature control elements 30 can be used together in conjunction and housed within the internal compartment 26.

In one embodiment, one or more interior walls of the compartment 26 can be lined with insulation. For example, the bottom wall of the compartment 26 can include an insulating layer, or a layer of insulation, to direct the hot or cold provided by the temperature control element 30 to the top surface of the serving vessel 10. The insulation may be a sheet of polyurethane foam, or a reflective or conductive insulator, or any combination thereof including materials other than polyurethane such as polystyrene. In one embodiment, the underside of the top 14 is lined with a heat distribution layer such as copper, aluminum, or graphene. Additionally, the main body 12 and panels 32 themselves help to isolate and insulate the temperature control element 30, allowing for the temperature to be maintained for hours.

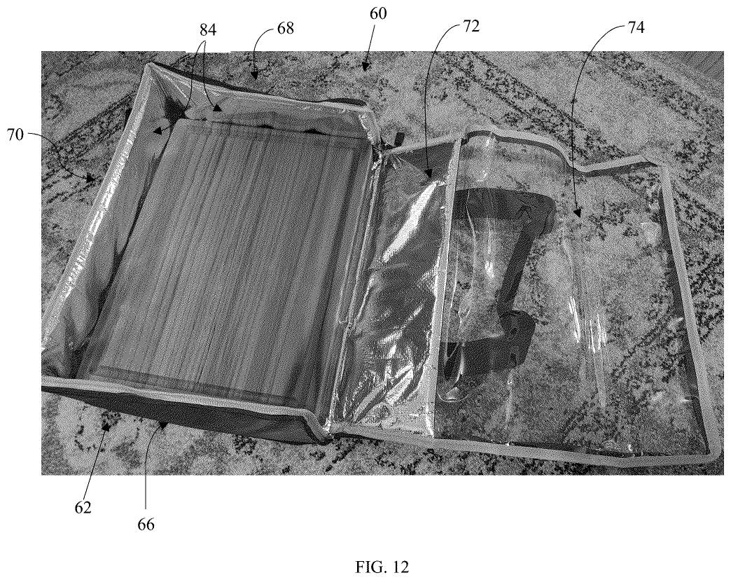

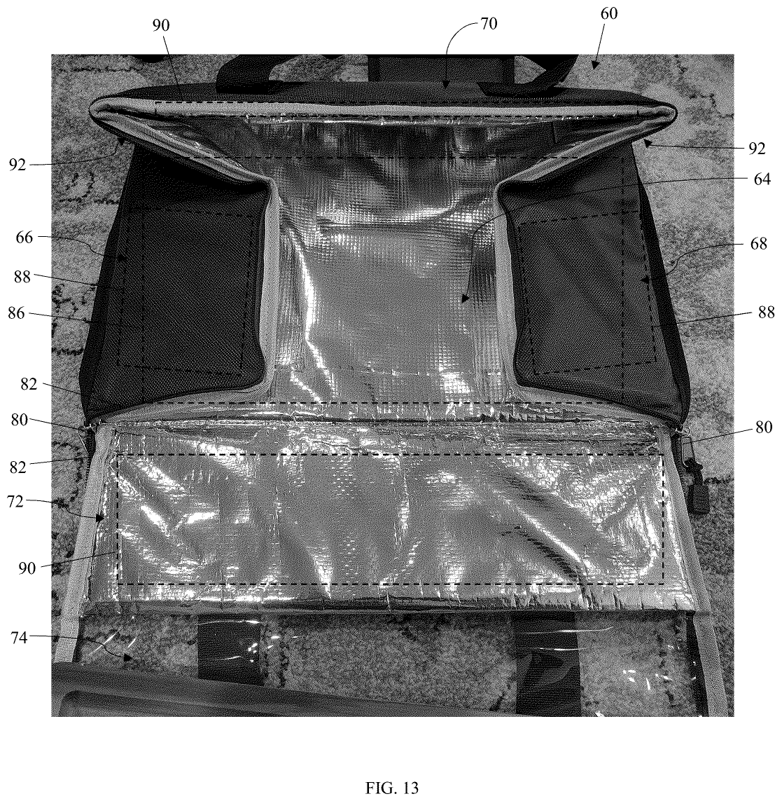

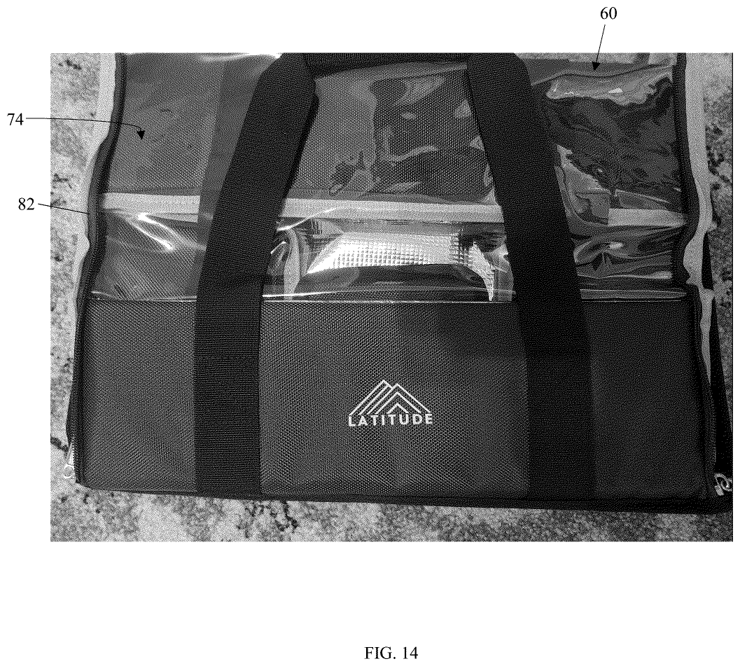

Referring specifically to FIGS. 11-14, in one embodiment, a food serving system can further include an insulated carrying bag 60 for housing and transporting the serving vessel 10 therein. Whether the serving vessel 10 is equipped with an ice pack or a hot pack, the carrying bag 60 can maintain a desired temperature of the food positioned on the serving vessel 10 during transport thereof. The carrying bag 60 includes a foldable and insulated shell 62 comprised of a rigid bottom wall 64 (FIG. 13), rigid side walls 66, 68, 70, 72 extending upwardly from the bottom wall 64, a completely unzippable clear top 74 removably connected to the side walls 66, 68, 70, 72, and handles 76 such as straps with a hook and loop fastener holder (unnumbered) to hold the straps 76 together. The carrying bag 60 may be positioned by the user in a closed, fully zipped position for insulating and transporting the serving vessel 10 (FIG. 11), an open, unzipped position for allowing access to and removing the serving vessel 10 (FIG. 12), a partially folded position (FIG. 13), and a stored, fully folded position wherein the top 74 is completely folded back onto the folded side walls (FIG. 14).

The clear top 74 allows users to visually inspect the food without needing to open the carrying bag 60, which would otherwise cause an unwanted loss or gain in temperature of the food. Additionally, the structural rigidity of the carrying bag 60 allows users to stack one or more bags (or other items) on top 74 of the carrying bag 60. Furthermore, given the structural rigidity of the carrying bag 60, the carrying bag 60 protects the serving vessel 10 and food thereon from sudden movement and foreign objects. Thereby, the carrying bag 60 advantageously transports, insulates, and protects the serving vessel 10 and food thereon.

The clear top 74 is completely removably via a multiplane zipper assembly 78, which includes one or more slider and pull tab mechanisms 80 and a multiplane zipper chain 82. The zipper chain 82 spans a portion of the perimeter of the clear top 74, e.g., its top edge and side edges but not the side edge connected to the side wall (defining a top zipper plane), and down each lateral side end of the zippable side wall 72 (defining a side zipper plane perpendicular to the top zipper plane). Fully unzipping the clear top 74 and zippable side wall 72 allows the user to outwardly and downwardly fold the clear top 74 and zippable side wall 72, away from the remaining side walls 66, 68, 70, and furthermore allows the user to access and remove the serving vessel 10 from the top and/or side openings (formed by the now folded zippable side wall 72 and clear top 74), without tilting the main body 12 of the serving vessel 10. Thereby, the user may easily remove the serving vessel 10 with the food thereon from the top and/or side such that the serving vessel 10 is not overly tilted from its horizontal resting plane and does not come into contact with the carrying bag 60. Therewith, the user may easily grab one or more sides or slide their hand under the bottom 16 of the serving vessel 10 and lift upwardly and outwardly, without needing to dig their hands into a traditional bag and awkwardly attempt to remove the serving vessel 10 which is both time-consuming and perilous as the food will often shift or completely fall off the serving vessel 10 upon tilting the serving vessel 10 and/or undesirably contacting such a traditional bag. Therefore, the user can easily remove the serving vessel 10 from the carrying bag 60 without displacing the food thereon. As shown, the zipper assembly 78 includes two slider and pull tab mechanisms 80; however, only one slider and pull tab mechanism 80 may be equipped.

The shell 62 can be a canvas shell with insulated interior walls or thermal liner 84 (FIG. 12), comprised of aluminum foil, vinyl, pearl cotton, and/or plastic. As shown in phantom in FIG. 13, one or more rigid structural support members 86, 88, 90 can be respectively housed within the bottom and side walls 64, 66, 68, 70, 72 of the shell 62. The structural support members 86, 88, 90 can be comprised of rigid plastic, semi-rigid plastic, Kevlar®, or another rigid material. Each structural support member 86, 88, 90 may comprise a rectangular cross-section. Each structural member 86, 88, 90 may extend the full or partial length of each respective wall 64, 66, 68, 70, 72.

In one embodiment, to promote ease of foldability and reduce the overall profile of the carrying bag 60 in its stored position (as shown in FIG. 14), each lateral side wall 66, 68 can include a 45 degree hinge built within each structural support insert 88 thereof, thus allowing a portion 92 of each lateral side wall 66, 68 to fold back on itself to allow the longitudinal, unzippable side wall 70 (opposite the zippable wall 72) to completely fold downwardly and rest atop the folded side walls 66, 68 and bottom wall 64. Each hinge can comprise knuckles and a retaining pin extending therethrough. In another embodiment, each structural support member 88 within each lateral side wall 66, 68 can have an angled end, such as a 45 degree taper extending inwardly from its bottom to top, plus or minus 10 degrees, next to the unzippable wall 70, which accordingly allows the portion of each lateral side wall 66, 68 closest to the longitudinal side wall (and without any rigid support therein) to accordingly fold back on itself.

In one embodiment, all of the bottom and side walls 64, 66, 68, 70, 72 can include structural support members therein. In another embodiment, some but not all of the side walls 64, 66, 68, 70, 72 may include structural support members. For example, the zippable side wall 72 may not include a structural support member 90 therein. Additionally, in one embodiment, only the bottom wall 64 and the unzippable longitudinal side wall 70 can include a respective structural support member 86, 90.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present disclosure of a new and useful “TEMPERATURE CONTROLLED SERVING VESSEL” it is not intended that such references be construed as limitations upon the scope of this invention except as set forth in the following claims.

What is claimed is:

1. A food serving device comprising:
a main body configured to receive and serve food thereon, the main body including an internal compartment configured to receive a temperature control element therein; and
a panel selectively engageable with the main body and movable between a closed position and an open position,
wherein, when the panel is in the closed position, the panel closes the compartment and forms a contiguous enclosure with the main body such that the temperature control element is enclosed within the compartment, and
wherein, when the panel is in the open position, the panel exposes the compartment such that the temperature control element can be removed from the compartment.

2. The device of claim 1, wherein:
the main body further comprises a top, a bottom, and an open side; and
the panel comprises an elongated side panel with a shape and size that corresponds to the open side such that, in the closed position, the elongated side panel fully covers the open side.

3. The device of claim 1, wherein:
the main body further comprises a pair of grooves; and
the panel is slidably engaged within the grooves of the main body.

4. The device of claim 1, wherein:
the main body further comprises a compartment opening in a side of the main body; and
the compartment opening comprises a pair of grooves configured to receive top and bottom sides of the panel such that the panel is slidably engaged therein.

5. The device of claim 4, wherein the compartment opening further comprises a lip configured to extend over an end of the panel, the lip having a groove therein configured to receive the end of the panel.

6. The device of claim 1, wherein:
the main body further comprises a first longitudinal side, a second longitudinal side, and a lateral side extending in between the first and second longitudinal sides;
the lateral side of the main body including a compartment opening therein; and
the compartment opening extends through the first longitudinal side of the main body.

7. The device of claim 6, wherein:
the panel is configured to slide across the compartment opening in a pair of opposing grooves in a top and a bottom of the main body from the first longitudinal side and toward the second longitudinal side until the panel covers the compartment opening in the lateral side of the main body.

8. The device of claim 1, wherein:
the main body further comprises a magnet embedded within a panel-mating surface thereof; and
the panel further comprises a corresponding magnet in a body-mating surface thereof such that the panel is magnetically engaged with the main body to retain the panel in the closed position.

9. The device of claim 1, wherein the panel further comprises:
an elongated and rectangular body with a first end and a second end opposite the first end; and
a handle at the first end.

10. The device of claim 9, wherein the handle comprises a rounded protrusion extending outwardly from the elongated and rectangular body.

11. The device of claim 9, wherein the handle matches a contour of the main body when the panel is engaged with the main body in the closed position.

12. The device of claim 1, wherein the panel is completely removable from the main body.

13. The device of claim 1, wherein the main body is comprised of wood and forms a cutting board with a drip groove in a top thereof, and the device further comprises the temperature control element.

14. The device of claim 1, wherein the panel is comprised of wood.

15. The device of claim 1, further comprising an insulating layer removably disposed within the compartment on a bottom of the compartment.

16. The device of claim 1, further comprising an insulated carrying bag configured to encase and transport the assembled main body and panel, the insulated carrying bag comprising:
a rigid bottom wall;
rigid side walls extending from the bottom wall, one side wall comprising a zippable side wall;
a zippable clear top removably connected to the side walls; and
a multiplane zipper assembly comprising a slider and pull tab mechanism and a zipper chain extending around a portion of the perimeter of the clear top and each lateral side end of the zippable side wall, allowing a user unzip and outwardly and downwardly fold the clear top and zippable side wall and furthermore allowing the user to access and remove the main body from the now unzipped clear top and zippable side wall, without tilting the main body.

17. The device of claim 16, wherein:
the rigid bottom wall comprises a rigid structural support member; and
each rigid side wall comprises a rigid structural support member.

18. A food serving device comprising:
a main body configured to receive and serve food thereon, the main body including an internal compartment with a compartment opening in a side of the main body;
a temperature control element removably disposed within the internal compartment and configured to maintain a temperature of the food on the main body; and
a panel selectively slidable within the compartment opening of the main body and configured to slide in a first direction to cover the compartment opening and enclose the temperature control element within the compartment in a closed position and slide in an opposite second direction to expose the compartment opening, allowing a user to remove or insert the temperature control element within the internal compartment.

19. The food serving device of claim 18, wherein the temperature control element is one of:
a refrigeration pack configured to cool the food on the main body; and
a hot pack configured to warm the food on the main body.

20. A food serving device comprising:
a main body configured to receive and serve food thereon, the main body including a top, a bottom, longitudinal sides, lateral sides, and an internal compartment with a pair of compartment openings thereof in both lateral sides;
a temperature control element removably disposed within the internal compartment and configured to maintain a temperature of the food on the main body; and
a pair of panels selectively and respectively slidable within the pair of compartment openings of the main body, each panel configured to slide in a first direction to cover its respective compartment opening and enclose the temperature control element within the compartment in a closed position and slide in an opposite second direction to expose its respective compartment opening, allowing a user to remove or insert the temperature control element within the internal compartment.
